(19) United States
(12) Patent Application Publication
(10) Pub. No.: US 2003/0018508 A1
(43) Pub. Date: Jan. 23, 2003

(54) Data-triggered workflow processes

(76) Inventor: Robert W. Schwanke, North Brunswick, NJ (US)

Correspondence Address: Siemens Corporation, Intellectual Property Department, 186 Wood Avenue South, Iselin, NJ, 08830, US

(21) Appl. No.: 09/908,953

(22) Filed: Jul. 19, 2001

(51) Int. Cl. G06F 17/60

(52) U.S. Cl. 705/9

(57) ABSTRACT

A data-triggered process definition language is employed, wherein each activity specified in a preferred process definition language is permitted to be enacted whenever a specified combination of data conditions is met, regardless of which activities have previously been enacted. A data-triggered workflow engine utilizes a current state of a process instance, the permitted and schedule rules, an activity network, and additional attributes of activities to schedule the enactment of activities. The activity network does not completely prescribe the enactment order, but rather controls what enactment order the data-triggered workflow engine will suggest to a participant. A participant, however, may select a different order based on other information, and can even enact activities that have not been scheduled.

### BACKGROUND

1. Technical Field

The present invention relates generally to a system and method for managing workflow processes and, more particularly, to a system and method for managing workflow processes, wherein a workflow definition language (syntax and semantics) and workflow engine are provided for implementing a data-triggered workflow process.

2. Description of Related Art

Workflow management is an emerging software technology that is employed to coordinate computer-supported human activity by monitoring the progress of work and informing people what activities they should do next. There are various workflow management products that are commercially available, but most of them are immature or specialized. Some standardization of the marketplace has taken place under the leadership of the Workflow Management Coalition (WfMC), which has issued several documents defining standard specifications, terminology, reference architectures, etc., (see, e.g., www.wfmc.org), with the goal of enabling interoperability between heterogeneous work flow management products and improved integration of workflow applications with other IT services such as electronic mail and document management.

A Workflow Management System (as defined by the WfMC specifications) is a system that defines, creates and manages the execution of workflows through the use of software, running one or more workflow engines, which is able to interpret a process definition, interact with workflow participants and, where required, invoke the use of IT tools and applications (see, e.g., the Workflow Management Coalition Terminology and Glossary, Document Number WFMC-TC-1011, Issue 3.0, February, 1999, which is incorporated herein by reference.) The term workflow refers to the automation of a business process, in whole or in part, during which documents, information or tasks are passed from one participant to another for action, according to a set of procedural rules.

FIG. 1 illustrates the relationships between basic terminologies of a workflow management system according to the WfMC. A business process comprises a set of one or more linked procedures or activities, which collectively realize a business objective or policy goal, typically within the context of an organizational structure defining functional roles and relationships. A business process is represented by a process definition in a form that supports automated manipulation, such as modeling, or enactment by a workflow management system. A process definition may comprise references to sub processes, separately defined, which make up part of the overall process definition.

A process definition comprises a network of activities and their relationships, criteria to indicate the start and termination of the associated process, and information about the individual activities, such as participants, associated IT applications and data, etc. An activity is a description of a piece of work that forms one logical step within a process. Although an activity may comprise either a “manual” or “automated” activity, only automated activities form part of the automated workflow resulting from the computer-supported execution of the process.

An activity (automated) is scheduled by a workflow engine during process enactment. A workflow engine comprises a software program that provides operational functions to support the execution of (instances of) a business process, based on the associated process definition.

A process instance represents a single enactment of a process, wherein a process instance is created, managed and (eventually) terminated by the workflow management system. A process instance comprises one or more activity instances.

An activity instance comprises a representation of an activity within a process instance. An activity instance comprises work items and/or invoked applications. A work item represents the work to be processed (by a workflow participant) in the context of an activity within a process instance. An invoked application comprises a workflow application that is invoked to automate an activity, fully or in part, or to support a workflow participant in processing a work item.

A workflow participant comprises a resource (typically a human) that performs the work represented by a workflow activity instance.

The currently available process definition languages and their associated interpreters (i.e., workflow engines) describe workflows using a “state-based paradigm”, for example in activity networks, which prescribe the order in which activities associated with a given process instance will be enacted (carried out). A network of activities (or process) can be visualized as a diagram comprising boxes representing activities and arrows representing ordering, or sequencing, relationships between activities. Besides simple sequential relationships (“After A comes B”), these languages often support concurrency (such as and-split and and-join connectors), guards (e.g., “When A completes, if P, then do B”), subroutines, spawning new process instances, loops, and other control constructs.

FIG. 2 is a diagram illustrating an exemplary activity network comprising a process instance in a conventional process definition language. The exemplary process instance comprises an activity network 20 comprising a plurality of activities: a Start activity 21, a Develop activity 22, an Integrate activity 23, a Test activity 24, a Release activity 25, and a Finish activity 26. The exemplary activity network 20 further comprises a decision node 27. The associated process instance enacts the Start activity 21 once, then repeatedly enacts the Develop, Integrate, and Test sequence of activities 22, 23, 24. Each time the Test activity 24 is completed, a decision 27 is made whether to enact the Release activity 25 or repeat the previous activity sequence 22-24, based on whether the outcome of the Test activity 24 was “pass” or “fail”. Once the Release activity 25 has been enacted, the Finish activity 26 is enacted and the process 20 ends. As noted above, an activity specifies a simple or composite work item to be performed by a worker. Typically, the activity specifies how to fill in details of the work item specification based on workflow-relevant data, which comprises data pertaining to the business process that can be accessed by an associated workflow process instance. A conventional activity typically progresses through a set of states, such as those defined by the WfMC Interface 2 API (application program interface), as illustrated in FIG. 3. The Interface 2 API of the WfMC Workflow Reference Models defines an API for interaction between a Workflow Management System and the client application and work list handler software (see, e.g., Workflow Management Application: Programming Interface (Interface 2 & 3): Specification, Document Number WFMC-TC-1009, July-98; David Hollingsworth, Workflow Management Coalition: The Workflow Reference Model, Document Number TC00-1003, Document Status —Issue 1.1, 19-Jan-95).

In FIG. 3, an open state 37 comprises a notrunning state 31, a running state 32 and a suspended state 34 having the state transitions as shown, and a closed state 38 comprises a completed state 33, terminated state 35 and aborted state 36. A conventional activity 30 is instantiated, in the state notRunning, typically when the process containing the activity is instantiated or when the activity or activities that precede it in the activity network are completed. The workflow engine (which interprets the process definition) typically creates the corresponding work item and places it on the work lists of one or more workers or other workflow participants who have the right skills and authorization to carry out the work item. A workflow participant might be an intelligent agent, rather than a human. The terms workflow participant and participant as used herein are synonymous. A work list handler typically displays a work list on a worker's computer screen, whereby the worker picks a work item from the work list, enacts it, and notifies the work list handler that the work item has been completed. When the participant picks the task from the work list, the workflow engine changes the activity state from notRunning 31 to running 32.

When the work item is successfully completed, the activity state changes from running state 32 to a completed state 33 and the activity instance is destroyed 39. If the participant decides not to complete the work item, the participant can cancel it, in which case the state changes from running 32 back to notRunning 31. The model of FIG. 3 illustrates additional states, suspended 34, aborted 35, and terminated 35 to cover situations such as setting a work item aside temporarily to do another work item, or terminating a work item in an abnormal way so that the activities that would normally follow it are not scheduled.

When an activity 30 reaches the completed state 33, the workflow engine checks the associated process definition, determines which activity or activities should be enacted next, and changes their states to ready. For simplicity, assume that in the exemplary process described above with reference to FIG. 2, exactly one activity is open at a time. Then, the process state (i.e., the representation of the internal conditions defining the status of a process instance at a particular point in time) of the exemplary process can be summed up by giving the name and state of the open activity.

The process state semantics for full-function conventional languages are more complicated. For example, concurrency allows multiple activities to be open at the same time. Nonetheless, conventional workflow modeling languages can thus be seen to use a state-based paradigm. This paradigm is well suited to enterprises in which the work is routine and “job-oriented”. By “job-oriented”, we mean work like insurance claim processing, loan approval, or the like, where a “job” (e.g. an insurance claim, loan application, or purchase requisition) enters the system, is worked on by several people in a fairly standard order, and is completed.

In such enterprises, one can typically specify a “main” process definition that describes how to handle a certain type of job. When such a job enters the system, the workflow management system creates a process instance of the appropriate process definition and begins executing it, connecting that process instance to the workflow-relevant data associated with the job.

“State-based” process definition languages require that the process definition specify all of the legal sequences of activities, wherein the activity network specifies that a certain activity becomes open only when certain other activities have been enacted first. As such, state-based process definition languages are generally not well suited for enterprises where work is collaborative, creative, or otherwise “non-deterministic”. For example, although workflow management systems have been proposed as a beneficial technology for integrating healthcare enterprises, particularly radiology departments of hospitals, the “business processes” of such enterprises can vary in their predictability from very routine (e.g. one more broken arm) to very unpredictable (e.g. patient with multiple pre-existing conditions develops symptoms of heart disease, may need by-pass surgery). In business processes where unpredictable circumstances can call for activities to happen outside of the usual order, trying to program all the allowable sequences of states in an activity network using such a language can be burdensome and difficult, and result in very complicated and hard-to-read programs. Furthermore, it is difficult to be sure that such programs actually cover all the situations that may occur.

Referring to FIG. 4, consider the activity “Add Test Case” in the diagram below. Suppose the intended business process is this:

In addition to the normal workflow, a worker is permitted to enact “Add Test Case” at any time. Afterwards, “Test” must eventually be enacted, even if it has been enacted before.

A conventional, “state-based” workflow management system would not accept this activity network because it does not specify any path leading from the Start activity 21 to the Add Test Case activity 28. One way to solve the problem would be to create a separate copy of the Add Test Case activity 28 at each place in the workflow where it is permitted, adding OR-split and OR-join connections to show that it is an optional activity. The resulting activity network, however, would have almost twice as many nodes and three times as many edges as the given network. If there were two or more optional activities instead of just one, the graph would grow combinatorially—or worse—with the number of such activities. This solution assumes that only one activity is enacted at a time. Trying to solve the problem using a concurrent activity network leads to different complexities.

These complexities arise because the added part of the business process is fundamentally data-triggered, rather than being state-based. The need for a new test case arises when the developer, integrator, or tester notices something in the application data. Once a new test case is added, previous test results are obsolete. The obligation to enact “Test” is caused by the fact that the test suite is newer than the most recent test results, not by the fact that “Add Test Case” was enacted.

Therefore, a system and method for providing workflow management, wherein a workflow definition language (syntax and semantics) and workflow engine are provided for implementing a data-triggered workflow process, are highly desirable.

### SUMMARY OF THE INVENTION

The present invention is directed to a system and method for providing data-triggered workflow management. In one aspect, the invention defines a data-triggered process definition language. Each activity specified in a preferred process definition language is permitted to be enacted whenever a specified combination of data conditions (the permitted rule) is met, regardless of which activities have previously been enacted. An activity is scheduled for enactment when a stricter combination of data conditions become true (the schedule rule). A data-triggered workflow engine comprises an activity scheduler that utilizes the current state of a process instance, the permitted and schedule rules, an activity network, and additional attributes of activities to schedule the enactment of activities. In contrast to conventional process definition languages, however, an activity network does not completely prescribe the enactment order, but rather controls what enactment order the data-triggered workflow engine will suggest to a participant. The activity scheduler computes attributes of activities that suggest an order in which to enact the activities, based on the information it has. A participant, however, may select a different order based on other information, and can even enact activities that have not been scheduled. The activity scheduler does not assume that the suggested order has been followed. It simply responds to each activity enactment event (e.g. start, finish, cancel) by revising the suggested enactment order.

In another aspect of the present invention, where the activities take place in a distributed system, requiring that data be copied from one place to another for use in different activities, activity definitions of a data-triggered process definition language comprise input, output and auto-routing specifications that are used by support software to automate the data movement.

In yet another aspect, activities specify data-triggered exceptions. When the specified data condition occurs while the activity is being enacted, a message is sent to the activity advising it that the exception has occurred. Typically, the activity will then abort.

These and other objects, features and advantages of the present invention will be described or become apparent from the following detailed description of preferred embodiments, which is to be read in connection with the accompanying drawings.

### BRIEF DESCRIPTION OF DRAWINGS

FIG. 1 is a flow diagram illustrating a workflow management method according to the WfMC standard;

FIG. 2 is a flow diagram of an exemplary state-based activity network according to the prior art;

FIG. 3 is a state transition diagram for an activity of an exemplary process, illustrating the progression of an activity through a set of states that are defined by the WfMC Interface 2 API;

FIG. 4 is a flow diagram illustrating a data-triggered activity network according to an exemplary embodiment of the present invention;

FIG. 5 is a block diagram of a data-triggered workflow management system according to an embodiment of the present invention; and

FIG. 6 is a flow diagram illustrating a method for executing a process instance according to one aspect of the present invention.

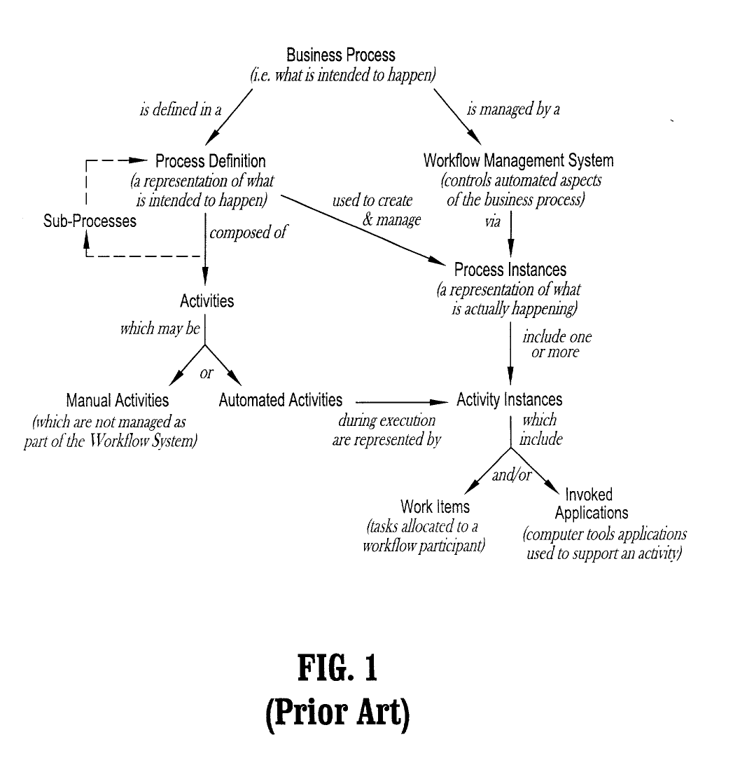

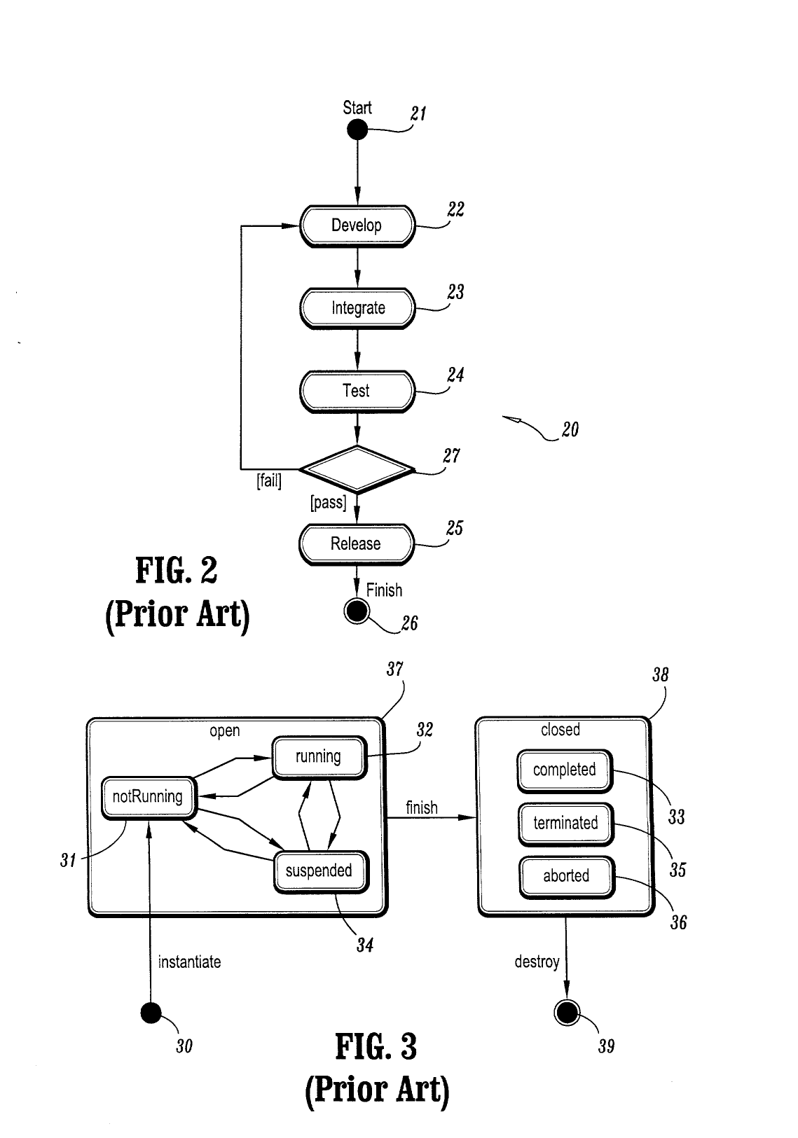

### DETAILED DESCRIPTION OF PREFERRED EMBODIMENTS

The present invention is directed to a system and method for providing data-triggered workflow management. The present invention is applicable for any enterprise, such as healthcare management, that permits a significant amount of unpredictability, or spontaneity, in its business processes. In general, a data-triggered workflow management system support business processes in which participants (typically humans) occasionally perform unscheduled activities. In particular, the present invention provides a novel data-triggered process definition language and various mechanisms that support unscheduled activities in various manners. It is to be understood that preferred embodiments of a data-triggered process definition language and workflow engine according to this invention comprise extensions of conventional workflow process definitions and components. The present invention utilizes conventional process definitions and components associated with workflow management as needed, which are not inconsistent with the mechanisms described herein, e.g., variations on the activity state diagram, types of nodes and edges in the activity network, subroutines, exception handling, and process instantiation.

By way of example, as explained in detail below, a preferred data-triggered process definition language according to a preferred embodiment of the invention extends conventional workflow protocols by implementing permitted, schedule, and expected rules that can be used to distinguish scheduled and unscheduled activities. Each activity specified in a preferred process definition language is permitted to be enacted whenever a specified combination of data conditions (the permitted rule) is met, regardless of which activities have previously been enacted. An activity is scheduled for enactment when a stricter combination of data conditions become true (the schedule rule).

A data-triggered workflow management system analyzes the current state of a process instance, the permitted and schedule rules, an activity network, and additional attributes of activities to schedule the enactment of activities. In contrast to conventional process definition languages, an activity network specification according to the present invention does not completely prescribe the enactment order, it only controls what enactment order the workflow engine will suggest. A data-triggered workflow management system computes attributes of activities that suggest an order in which to enact the activities, based on the information that the system has. A workflow participant may choose a different order of activities based on other information, and can even enact activities that have not been scheduled at all. The data-triggered workflow management system does not assume that the suggested order has been followed, but responds to each activity enactment event (e.g. start, finish, cancel) by revising the suggested enactment order.

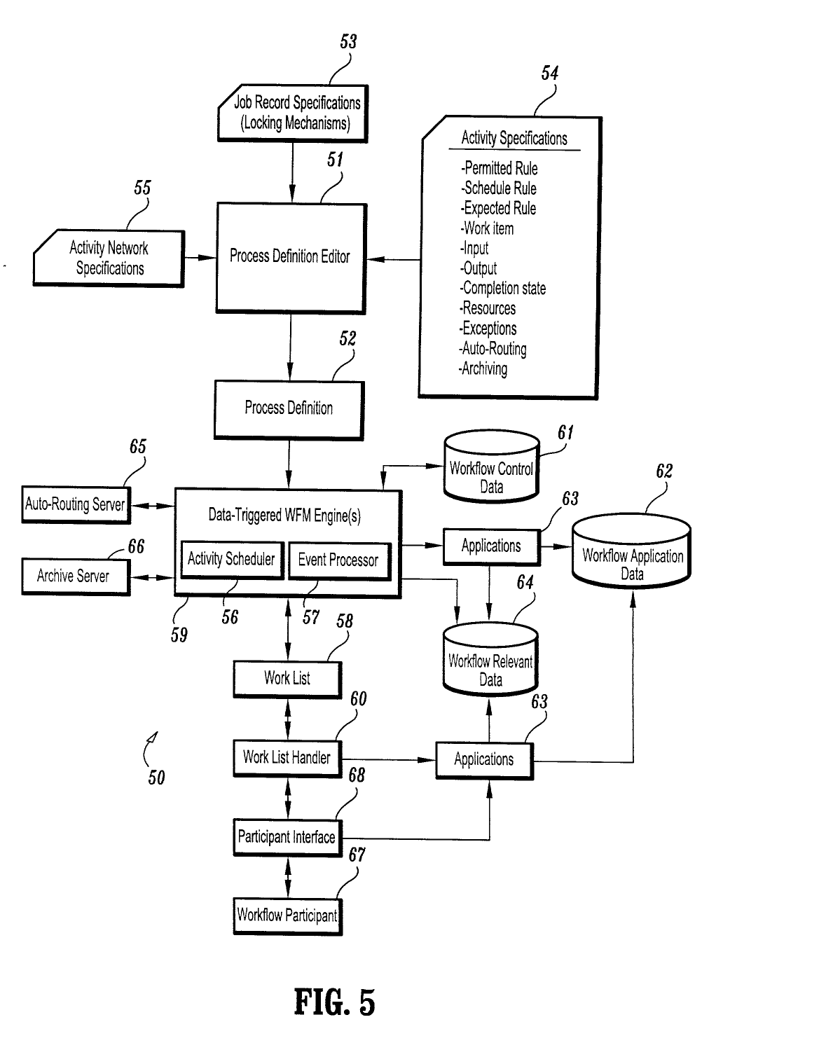

Referring now to FIG. 5, a block diagram illustrates a data-triggered workflow management system according to an embodiment of the present invention. The system comprises a process definition editor 51 (e.g., specific tool, text editor, etc.) for generating one or more process definitions 52 using a data-triggered workflow definition language (syntax and semantics). A data-triggered workflow definition language comprises a plurality of specifications comprising job record specifications 53, activity specifications 54, and activity network specifications 55. Each of these specifications will be described in detail below.

The system 50 further comprises a data-triggered workflow engine 59 that, e.g., interprets a process definition 52 to instantiate and execute a process instance of the defined process, as well as manage the execution of the process. The data-triggered workflow engine 59 comprises an activity scheduler 56 and an event processor 57. The event processor 57 monitors changes to workflow relevant data 64 and to the states of activities, propagating their effects to the states of other activities. The activity scheduler 56 computes attributes of activities that suggest an order in which to enact the activities and dynamically revises a suggested enactment order based on activity enactment events. A more detailed discussion of the operation of the workflow engine 59 and activity scheduler 56 and event processor 57 will be provided below.

The system 50 further comprises a plurality of persistent storage devices for storing data. For instance, the system 50 comprises a workflow control data store 61 for storing data representing the dynamic state of the system 50 and the process instances, which is managed by the system 50 and engine 59. In addition, an application data store 62 is provided for storing data that is managed by one or more applications 63 supporting a process instance. Further, a workflow-relevant data store 64 comprises a pool of data, typically transactionally persistent, that is accessed by the applications 63 that support human activities and by the data-triggered workflow engine 59 during execution of workflow processes. The workflow-relevant data is used by the system 50 to determine state transitions of a workflow instance. For example, application data that is referenced in the guard (precondition) of an activity is workflow-relevant data.

The system 50 further comprises an auto-routing server and an archive server 66. When activities are enacted in a distributed system, wherein data is required to be copied from one location to another for use in different activities, the input and output specifications and auto-routing specifications comprising the activity specifications 54 are used by the system 50 to automate the data movement. Details regarding the functions and roles of the auto-routing server are provided below. Further, as discussed in detail below, the archive server 66 copies the data generated by an activity to a specified location based on archiving specifications of the activity specifications 54.

A workflow participant 67 (e.g., person) interacts with the system 50 via a participant interface 68. A worklist handler 60 manages the interaction between the participant 67 and a worklist 58 maintained by the engine 59. The worklist handler 60 allows the participant 67 to, e.g., select a work item from the worklist 58. The work items represent the work to be processed in the context of an activity within a process instance.

A detailed discussion of preferred components of a data-triggered process definition language and of preferred methods and systems for workflow management according to the present invention will now be provided.

I. PROCESS DEFINITION: In accordance with one aspect of the present invention, a process definition 52 comprises:

(A) a job record specification 53;

(B) a set of activity specifications 54; and

(C) an activity network specification 55.

In general, when the data-triggered workflow engine 59 creates an instance of a process definition 52, it creates an instance of the job record specification and a data structure representing the execution state of the process instance. The execution state includes any process-private data and instances of the activities of the process, with their states. In addition, for applications where an audit history is needed, the execution state may further comprise an audit history of the execution of the process. In accordance with the present invention, the data-triggered workflow engine 59 uses the current execution state of a process instance, the activity specifications 54, and the activity network 55 to determine which activities are permitted to be enacted, which activities are scheduled for enactment, and the priority characteristics for the scheduled activities.

I(A). Job Record Specification: A job record specification 53 according to the present invention defines all the data needed to carry out a certain type of job, including input data (e.g. the work order), intermediate results, and output data that will be delivered as part of the completed job. Job data typically also comprises references to other workflow-relevant data that is shared among several jobs. Other embodiments of the present invention comprise locking mechanisms that allow a process instance to have exclusive access to shared data objects during certain execution intervals.

I(B). Activity Specification: An activity specification 54 according to the present invention comprises: (i) an optional permitted rule specification; (ii) a schedule rule specification; (iii) an optional expected rule specification; (iv) a work item specification; (v) an optional input specification; (vi) an optional output specification; (vii) an optional completion state specification; (viii) an optional resources specification, (ix) an optional exceptions specification, (x) an optional auto-routing specification; and (xi) an optional archiving specification, each of which is described below in detail. For each of the optional specifications, a default value is preferably used when the specification is omitted.

In general, an activity may only be enacted when its permitted rule is true. An activity is scheduled to be enacted whenever its schedule rule is true and it is not already open. The expected rule informs the activity scheduler 60 to assume that the activity will be enacted in the future, and therefore to plan ahead for its resources, auto-routing, etc. An activity may only read data that is listed in its input specification and may only write data that is listed in its output specification. The permitted rule, the schedule rule, and the expected rule may only refer to data in the input specification. When an activity reaches the state completed, it also has a completion-state. Each time that any workflow-relevant data changes, including data in job records, the data-triggered workflow engine checks to see which activities' rules are affected by that data and updates the list of scheduled activities accordingly.

I(B)(i). Permitted Rule: A permitted rule according to the present invention comprise a Boolean expression over the activity inputs that specifies whether the current state of the job allows the activity to be enacted. As a default, the schedule rule is preferably used as the permitted rule.

I(B)(ii). Schedule Rule: A schedule rule according to the present invention comprises a Boolean expression over the activity inputs that specifies the conditions under which the data-triggered workflow engine should schedule the activity for enactment. The difference between the permitted rule and the schedule rule is that the permitted rule is checked when the participant takes the initiative to do an activity, whether or not it is on a worklist. The schedule rule directs the data-triggered workflow engine to take the initiative to inform the participant that the participant should perform an activity (typically by placing the activity on the worklist).

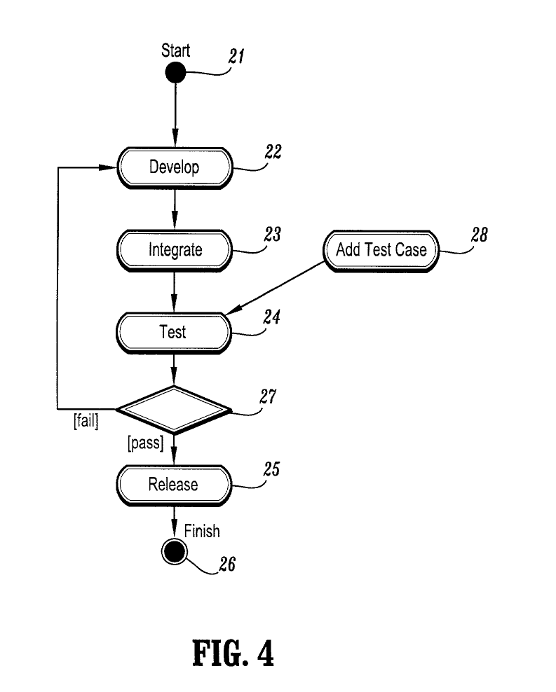

I(B)(iii). Expected Rule: An expected rule according to the present invention comprises a Boolean expression over the activity inputs that specifies whether the activity is expected to be enacted in the future, prior to the completion of the job. For example, in FIG. 4, if the latest version of the code is newer than the version that was tested, the Test activity 24 is expected to be enacted again, before the job is complete. The activity scheduler 60 uses the expected rule to plan ahead for activities that are not yet scheduled, or even permitted, to be enacted. The fact that an activity is expected does not guarantee that it will definitely be enacted in the future. In a preferred embodiment, the default value for an expected rule is “true, if the activity has never been in the running state, and false otherwise.”

It is to be appreciated that in addition to a preferred data-triggered workflow system as described herein, expected rules specifications may be implemented in any suitable workflow paradigm, such as in conventional state-based workflow paradigm described above.

I(B)(iv). Work Item Specification: A work item specification describes the work to be performed in the course of an associated activity. Typically, a work item specification comprises a template that the data-triggered workflow engine instantiates with information from the job record. As noted above, work items are presented to participants on worklists. The present invention can work with most conventional work item specification techniques.

I(B)(v). Input Specification: An input specification according to the present invention lists all of the data in the job record that the activity may need to read. If the same data might also be modified, it must be listed in the output specification. To improve efficiency, an input specification according to the present invention may differentiate input data that is used in different ways, such as “required” vs. “optional”, “permitted-only”, “schedule-only”, “copy” vs. “reference”, etc. The input specification may supply auto-route specifications (as explained below) for some or all of the input fields. As a default, the activity is assumed to read all input fields.

I(B)(vi). Output Specification: An output specification according to the present invention lists all of the data in the job record that a certain activity might produce, modify, or overwrite. There can be a different list for each output state. Each list item can be qualified with attributes like “always”, “maybe”, etc. Each list can have an associated predicate asserting properties of the data that are expected to be true when the activity completes in the named state. Whether the predicate is actually true depends on whether the workflow engine enforces it. The output specification may supply archiving specifications (as described below) for some or all of the output fields. As a default, the activity is assumed to modify all output fields.

I(B) (vii). Completion State Specification: A completion state specification according to an embodiment of the present invention comprises a list of names of the different activity outcomes (i.e., ways in which the activity could end). In one embodiment, a default specification is “{complete}”. Examples of other, useful completion state specifications comprise “{success, failure}”, “{approved, denied, appealed, withdrawn}”, etc. When the activity finishes, the activity sends a message to the data-triggered workflow engine to indicate which completion state was reached by the activity. Completion states are used, for example, in the rules of subsequent activities.

I(B)(viii). Resources Specification: In accordance with an embodiment of the present invention, a resources specification comprises the enterprise resources, such as people, workstations, equipment, supplies, file servers, and data storage space needed to enact the activity. An activity scheduler 60 according to an embodiment of the present invention utilizes the resources specification to select which scheduled activity instances should be enacted first. The resources specification can also be used, before an activity is permitted, to plan resource usage in advance. As a default, the activity is assumed to use no resources that require scheduling or affect priority.

I(B)(ix). Exceptions Specification: An exception specification according to an embodiment of the present invention comprises an unusual situation that requires abnormal processing, and which can occur while the activity is active. An exception may originate within the activity itself, or it might be imposed on the activity by some outside agent. For example, if a radiologist discovers that the patient cannot tolerate the procedure, that might be treated as an “internal” exception. On the other hand, if the clinician cancels the order while the radiologist is dictating the report, that might be treated as an “external” exception. The default for this specification is “no exceptions”.

It is to be appreciated that in addition to a preferred data-triggered workflow system as described herein, exception specifications may be implemented in any suitable workflow paradigm, such as in conventional state-based workflow paradigm described above.

I(B) (x). Auto-Routing Specification: Large enterprises with business processes involving large amounts of data can be distributed across many workstations and many file servers. This can create situations where one activity has produced, modified or overwritten some data, another activity is ready to use the data, but the data is not readily accessible at the workstation where the next activity will be performed. Moving the data, in advance of enacting the activity, is referred to herein as auto- routing. The term “auto-routing” used herein comprises data that is “pushed” to a subsequent activity location by the workstation that produced, modified or overwrote the data, and data that is “pulled” (e.g., from an archive) by a subsequent activity location.

The auto-routing specification 56 according to an embodiment of the present invention comprises a rule that lists which input data items to copy, and where to copy them, prior to commencing the activity. The auto-routing destination may be computed based on data in the job record. An embodiment of the auto-routing specification may comprises “mandatory” auto-routing and/or “preferred” auto-routing.

Mandatory auto-routing according to an embodiment of the present invention is typically specified for data that is required for the activity and cannot be accessed at all, from the workstation enacting the activity, unless auto-routed. Preferred auto-routing is typically specified for data that is either optional for the activity or is required but accessible, albeit slowly, without auto-routing. However, the choice of whether to specify preferred or mandatory auto-routing for a particular data item is up to the process designer.

An activity can commence as soon as the mandatory auto-routing is complete, but an activity may be carried out more efficiently or effectively if the activity is postponed until the preferred auto-routing is complete. The auto-routing status of an activity can be included in work lists so that participants can choose whether to wait for preferred auto-routing to complete.

An auto-routing rule according to the present invention may be used in various manners. For instance, the rule can be used to construct commands for moving data and/or to test whether mandatory auto-routing and/or preferred auto-routing has been completed. In a preferred embodiment, auto-routing specifications used by the data-triggered workflow engine comprise the following:

An activity is not permitted to be enacted until its permitted rule evaluates to true and its mandatory auto-routing test evaluates to true.

An activity is not made listed in the work item pool as ready to execute until its schedule rule evaluates to true and its mandatory auto-routing test evaluates to true.

A work item carries an attribute reflecting whether its preferred auto-routing is complete. This attribute can be used in work list queries and displayed in work lists.

Whenever a data item, D, is created or modified, the data-triggered workflow engine 59 collects and sends to the auto-routing module 65 all of the auto-routing specifications that potentially require D to be moved and/or belong to expected activities.

The auto-routing module 65 schedules and supervises the data movements based on available storage space, network traffic, activity deadlines, and any other relevant information.

The auto-routing module 65 notifies the data-triggered workflow engine 59 each time an auto-routing rule becomes satisfied, so that the engine can update the attributes of the affected activity.

Whenever an activity associated with an affected auto-routing rule stops being expected, the data-triggered workflow engine 59 notifies the auto-routing server 65 so it can cancel the associated copy commands.

It is to be appreciated that in addition to a preferred data-triggered workflow system as described herein, auto-routing specifications may be implemented in any suitable workflow paradigm, such as in conventional state-based workflow paradigm described above.

I(B) (xi). Archiving Specification: In some instances, it is desirable that data produced, modified or overwritten by an activity is copied to “a safe place” once the activity instance has been completed. An archiving specification 57 according to an embodiment of the present invention identifies which data should be copied, to where the data should be copied, and whether the copy should be made as part of the activity instance's transaction or as a separate, subsequent step. This distinction is important for fault tolerance in certain situations.

Whenever an activity instance enters the state completed, the data-triggered workflow engine passes the archiving specification of the activity to the background archiving server 66 to perform the copying. The archive server 66 notifies the data-triggered workflow engine 59 when the copying is complete. If so specified, the data-triggered workflow engine 59 delays completing the activity instance's transaction until it receives this notification.

It is to be appreciated that in addition to a preferred data-triggered workflow system as described herein, archiving specifications may be implemented in any suitable workflow paradigm, such as in conventional state-based workflow paradigm described above.

I(C). Activity Network:

An activity network specification 55 according to an embodiment of the present invention describes the normal order in which activities take place in the absence of “spontaneous” activities. In a preferred embodiment, an activity network is defined by two relations over the set of activities defined for a certain process:

(i) Precedes<X, Y> means that, “after enacting X, it may be necessary to enact Y”. A typical reason for this is that X produces, modifies or overwrites data that Y needs, but that is neither a necessary nor sufficient condition for Precedes<X, Y>. This relation is preferably partially ordered over the set of activities in a job.

(ii) Precedes-back <X, Y> is similar to the first relation, but is used to specify “back edges” in the ordering graph. The meaning of this relation is, “After enacting X, it may be necessary to re-enact Y”. It is used, for example, in situations where a sequence of activities should be repeated if its output fails a quality check.

An Activity Network according to the present invention comprises the union of the two relations Precedes<X,Y> and Precedes-back<X,Y>. This ordering relation is used, for example, when more than one activity's schedule rule is satisfied, to determine which activities should be enacted before others. Normally, X should be enacted before Y if Precedes*(X,Y), where Precedes* is the transitive closure of the Precedes relation. However, there may be situations where Precedes-back(Y,X) also influences the best enactment order.

II. Executing Process Instances:

In general, the data-triggered workflow engine 59 is responsible for supervising the execution of process instances. The data-triggered workflow engine performs this function by, e.g.,: (i) enforcing the rules of execution; (ii) creating and deleting work items and tracking their states and attributes; (iii) interacting with work list handlers to build work lists and receive enactment events; and/or (iv) responding to enactment events by updating the execution states of processes.

Preferably, a data-triggered workflow engine maintains work lists as follows. When an activity is instantiated, the engine instantiates a work item according to its specification and places the work item on all appropriate work lists, based on role specifications, participant profiles, etc., in a conventional manner. Participants select work items from work lists, begin enacting them, and then either finish enacting them or cancel them. Participant actions on work items cause work list managers to send events to the workflow engine, telling it to change the state of the corresponding activity instance. The workflow engine responds to messages from work lists by changing the states of the activity instances and the contents of the process instances and job records in the appropriate ways.

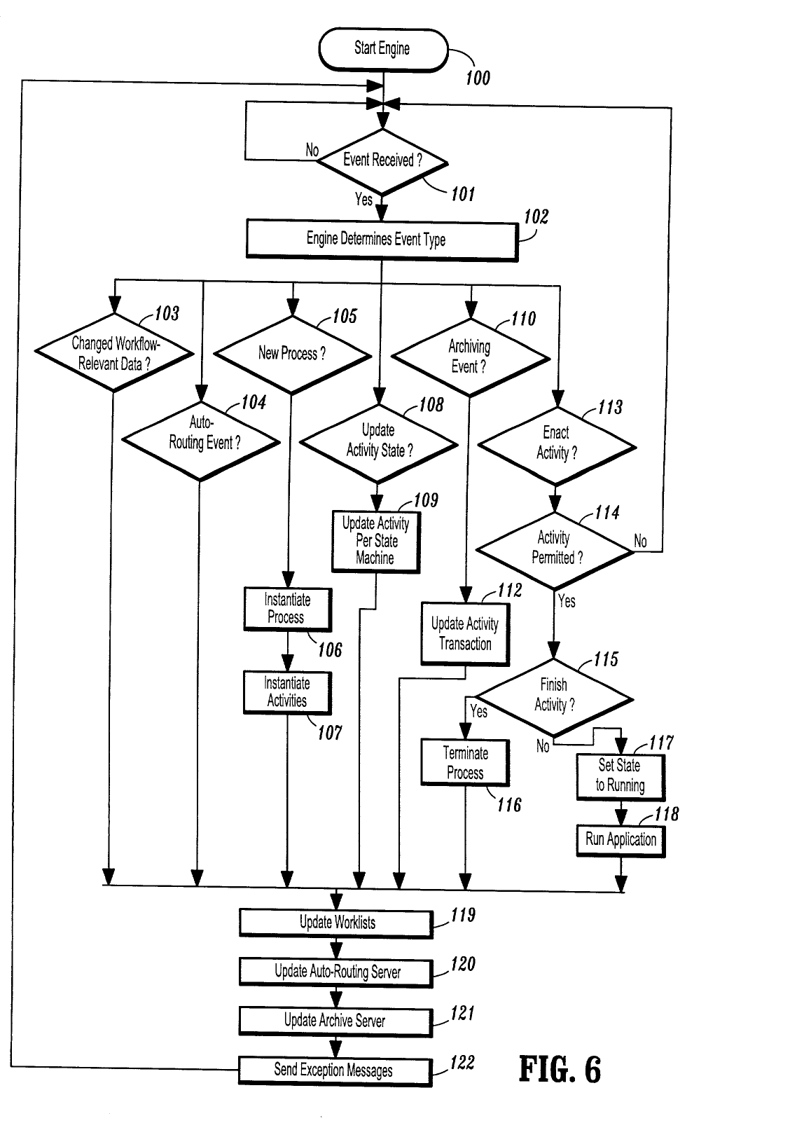

A preferred method of operation of a data-triggered workflow engine according to one aspect of the present invention will now be described with reference to the flow diagram of FIG. 6. After the workflow engine is started (step 100), the engine waits until it receives an event (step 101). Upon the occurrence of an event (i.e., an occurrence of a particular condition, which may be internal or external to the workflow management system) (affirmative determination in step 101), the engine proceeds to determine what type of event was received (step 102 ). If the event type is determined to be “changed workflow-relevant data”(affirmative result in step 103) or an “auto-routing event” (affirmative result in step 104), the workflow engine proceeds to steps 119-122 (discussed below).

If the event type is determined by the workflow engine to be a “New Process” (affirmative result in step 105), the engine will instantiate the process (step 106) including instantiating each of the process activities in the “notRunning” state (step 107), and then proceed to steps 199-122).

If the event type is determined by the engine to be an “Update Activity State” event (affirmative result in step 108), the engine will proceed to update the activity per state machine (step 109). More specifically, the workflow engine will examine the event parameters to determine which activity instance is affected and what kind of update is required, compare it to the current state of the activity instance (cf. FIG. 3) and change the state accordingly. The workflow engine will then proceed to steps 119-122.

If the workflow engine determines the event type to be an “Archiving event” (affirmative result in step 110), the engine will locate the activity instance that was waiting for the archiving action to complete, update the transaction and activity state of the activity instance accordingly (step 112) and then proceed to steps 119-122).

If the workflow engine determines the event type to be an “Enact activity” event (affirmative result in step 113), the workflow engine first evaluates the permitted rule of the requested activity instance to determine if the activity is permitted to be enacted (step 114). If the activity instance is not currently permitted (negative determination in step 114), the workflow engine rejects the request and returns to step 101 to wait for another event. On the other hand, if the requested activity instance is currently permitted (affirmative result in step 114), the workflow engine proceeds to determine whether the requested activity is a “Finish” activity instance (step 115). If so (affirmative determination in step 115), the workflow engine terminates the execution of the process instance comprising that activity instance (step 116), and proceeds to steps 119-122). It is to be understood that terminating an activity or process instance does not destroy it, since data in the process instance must be preserved for logging and other purposes. It is to be further understood that the “finish” activity, if permitted, preferably can be enacted (step 116), terminating the process instance, even if other activities are scheduled, Running, or still expected.

If the activity instance is not a “Finish” activity (negative determination in step 115), the activity state is set to Running (step 117), the engine activates any software application needed to carry out the corresponding work item (step 118), and the logic flow proceeds to step 119.

At step 119, in accordance with the present invention, a data-triggered workflow engine further processes received events by looking at their impact on the process data. It re-evaluates the permitted, schedule, and expected rules of the activity instances, to see which expressions have changed values, and then adjusts the work lists accordingly. The data-triggered workflow engine computes additional scheduling characteristics of activities and attaches the information to work items. For example, if two activity instances, X and Y, are both notRunning, and Precedes<X,Y>, then the work item for Y might include the attribute, “preceded by X”. The query that constructs a particular work list might or might not filter out such preceded activities, depending on the purpose of the work list.

The engine then sends updated information to the auto-routing server (step 120) and the archive server (step 121), detects any data-triggered exceptions and sends exception messages to the affected activities (step 122) and then waits for the next event to arrive (step 101).

It is to be appreciated that the optional specifications of an activity are used to make the workflow engine more efficient. For example, the input specification allows the engine to limit which ready rules it re-evaluates based on which data was changed. The completion state and output specifications allow the engine to examine only those job record fields that might have actually changed. Another embodiment of the activity scheduler uses input-output dependencies, estimated enactment times and resource requirements to perform schedule optimizations and bottleneck forecasting.

It is to be understood that various cases are considered with respect to when an activity may be enacted more than once. Three cases must be considered: (a) A process definition comprises two or more logically distinct activities with a shared specification (these activities are considered different activities); (b) A particular instance of an activity, once completed, might have to be re-enacted later (this is considered a repetition of the same activity, even though it most likely entails a new instance); and (c) A process explicitly replicates an activity several times, for example to process a list of similar data objects. The executions might overlap in time. These are considered different activities.

If desired for a particular application, an activity might be implemented as an indivisible transaction on the job record instance and the process instance data, to assure one or more of the following properties:

Any changes that the activity makes to workflow-relevant data, especially the job record, are made on an all-or-nothing basis.

The input specification may place locks on some inputs. Those fields may not be changed by any other activity instance while the present activity instance is running.

The schedule rule may place locks on some inputs, wherein those fields may not be changed while the activity is open.

III. State-based Schedule Rule That Supports Rework:

The following describes a state-based schedule rules specification 58 according to an embodiment of the present invention for defining schedule rules that make a process behave as if it were state-based whenever there are no unexpected activity enactments, but also responds sensibly in the presence of such unexpected enactments, such as rework. The following predicates help describe the schedule rules.

(i) In-Out-Consistent Predicate

An in-out-consistent predicate according to the present invention is specified individually for each activity, and captures the concept that one can decide whether an activity needs to be [re-] enacted by looking at its outputs in relation to its inputs. Thus, a preferred in-out-consistent predicate comprises a Boolean function of the inputs and outputs of an activity, whose value indicates whether the outputs are consistent with the inputs, as if the activity had just finished being enacted.

(ii) Prefix-Consistent Predicate

A prefix-consistent predicate according to the present invention is automatically constructed from in-out-consistent predicates, the activity network, and the rules of the activity network language. A purpose of the prefix-consistent predicate is to express the idea that there is a legal execution path through the activity network to a selected activity such that all of the activities on that path, up to but not including the activity itself, are consistent. Of course, if the network language allows concurrency, the “path” may be concurrent.

An activity is prefix-consistent if the guard on its in-edge is true and a specified subset of its predecessors are in-out-consistent and prefix-consistent, wherein the subset is preferably specified according to the type of edge leading into the activity, and wherein “predecessor” is defined by the Precedes*<X,Y>relation, and does not include the Precedes-Back<X,Y>relation. For example:

Once the Start activity has been enacted, it is prefix-consistent and in-out-consistent.

If the edge is an ordinary sequential edge, then its one and only predecessor must be prefix-consistent.

If the edge is an OR-join, then only one of the predecessors is required to be prefix-consistent.

If the edge is an AND-join, then all of the predecessors must be prefix -consistent.

If the specified subset is empty, the activity is prefix-consistent.

The Schedule Rule

In accordance with a preferred embodiment of the present invention, to simulate state-based scheduling while also supporting rework, a schedule rule for each activity is automatically constructed from the consistency predicates, as follows: The schedule rule for each activity is true whenever the activity has predecessors and is prefix-consistent, but is not in-out-consistent.

This rule simulates the state-based paradigm as long as there are no unscheduled activity enactments. Once the Start rule has been enacted, its successors' schedule rules will become true. Once they are enacted, their successors' schedule rules will become true, and so forth. Wherever there is a back-edge in the activity graph, the in-out-consistent rule for the target activity of the edge will include clauses that check whether data changes potentially caused by the source activity require the target to be re-enacted.

When an unscheduled activity does occur, the schedule rules take care of deciding which normal activities need to be re-enacted, or not enacted at all. It schedules the enactment in the standard order, except for skipping activities that do not need to be enacted because they are already in-out-consistent. The following examples illustrate how the enactment sequence is affected.

In one example, an ad hoc action (not really an activity at all) could change some job data, making a previously-enacted, consistent activity inconsistent. That activity's schedule rule would become true, and, once it was enacted, any subsequent, inconsistent activities would be scheduled and enacted. There may be some subsequent activities that remain in-out-consistent even after their predecessors are re-enacted; they are skipped over during re-enactment.

In another example, an activity might be enacted earlier than it would normally be scheduled, making it in-out-consistent, at least temporarily. Whether it is scheduled and re-enacted later depends on whether it is still in-out-consistent once it becomes prefix-consistent.

IV. Unscheduled Human Activities:

As noted above, a primary motivation for this invention is to support business processes in which participants (typically humans) sometimes need to perform unscheduled activities. Advantageously, the present invention supports unscheduled activities in various manners. For instance, the present invention recognizes permitted, schedule, and expected rules that can be used to distinguish scheduled and unscheduled activities. Further, the present invention provides a mechanism for receiving and responding to external events. These mechanisms distinguish and support the following types of human activities, where the “constraints” give characteristics of the rules for that kind of activity.

| Activity type | Constraints | Description |
|---|---|---|
| Strictly scheduled | Permitted η | Only enacted when scheduled |
| | Scheduled | |
| Loosely scheduled | Permitted_{—} | Can be enacted even when not |
| | Scheduled | scheduled |
| Unscheduled | Scheduled η false | Never scheduled |
| Expected but | Scheduled η false | Can plan ahead for an activity, |
| Unscheduled | | even if it will not |
| | | be scheduled. |
| Unexpected | Expected η false | No way to predict, |
| | | based on workflow-relevant |
| | | data, when - or whether - |
| | | the activity will happen. |
| Required | Scheduled η false | A clause is added to the |
| | | permitted rule of the |
| | | Finish activity to |
| | | effectively prevent the process |
| | | from finishing until the |
| | | activity has been enacted. |
| Ad hoc | | Not specified as a workflow |
| | | activity, but causes |
| | | changes to workflow-relevant |
| | | data, reported |
| | | through events. |

V. Other Workflow Management Functionality:

The present invention is applicable as an enhancement to most workflow management systems. For example, the process definition language and data-triggered workflow engine described herein is preferably interoperable with conventional workflow management systems. Each activity in a data-triggered process could execute a sub process written in a conventional language. Conversely, a conventional process should be able to invoke a data-triggered sub process. Whatever work list services a conventional system provides should be applicable to data-triggered workflow management, with extensions for additional attributes computed by the data-triggered workflow engine. Although the invention is described in relation to the WfMC standard activity state model, it is intended to be applicable in a comparable way to other activity state models. Although the invention has been described as if the participants were normally human, it is equally applicable to activities enacted by intelligent agents, and to invoked applications.

Although illustrative embodiments have been described herein with reference to the accompanying drawings, it is to be understood that the present invention is not limited to those embodiments, and that various other changes and modifications may be effected therein by one skilled in the art without departing from the scope or spirit of the invention. For instance, it is well known to those skilled in the art that, when creating a specification language and an interpreter for such language, the developer has many options when deciding whether to incorporate a particular component or functionality in the interpreter or in the language. By incorporating desired components or functionalities in the interpreter, the resulting system can be rendered more specialized and/or efficient, whereas incorporating desired components and functionalities in the language renders the system more general purpose.

For example, in another embodiment of the present invention, it is possible to implement much of the data-triggered workflow engine functionality in the process definition language of a conventional workflow management system. Indeed, the principles of data-triggered workflow management may be hand-programmed into conventional workflow process definitions by, e.g., adding extra steps that perform the tests that a data-triggered workflow engine preferably performs. Conversely, it is possible to hard-code particular activity specifications (e.g., permitted, expected, allowed, auto-routing, archive rules) within the workflow engine, rather than allowing each processed specification to have different rules. Therefore, all such changes and modifications are intended to be included within the scope of the invention as defined by the appended claims.

What is claimed is:

1. A system for providing data-triggered workflow management, comprising:
a data-triggered process definition language for generating a process definition, wherein the process definition comprises a job record specification, an activity specification, and an activity network specification, wherein the activity specification comprises schedule rules for specifying conditions under which activities are scheduled for enactment;
a storage device for storing workflow-relevant data; and
a data-triggered workflow engine for generating a process instance from a process definition and managing the execution of the process instance, wherein the data-triggered workflow engine processes activity attributes and the schedule rules to determine an order in which the scheduled activities can be enacted.

2. The system of claim 1, wherein the data-triggered workflow engine re-evaluates the schedule rules when the workflow-relevant data is modified.

3. The system of claim 1, wherein the activity specification further comprises permitted rules for specifying conditions under which activities are permitted to be enacted.

4. The system of claim 1, wherein the activity specification comprises expected rules for specifying conditions under which activities are expected to be enacted.

5. The system of claim 1, wherein the activity specification comprises an input specification for listing data in a job record that an activity can read.

6. The system of claim 5, wherein the input specification further comprises at least one attribute for specifying a manner in which data for an input field is used.

7. The system of claim 1, wherein the activity specification comprises an output specification for listing data in a job record that an activity can produce, modify or overwrite.

8. The system of claim 1, wherein the activity specification comprises a completion state specification for listing at least one type of outcome for an activity.

9. The system of claim 1, wherein the activity specification comprises a resources specification for listing at least one resource that is needed to enact an activity.

10. The system of claim 9, wherein the data-triggered workflow engine utilizes the resources specification to determine an order in which scheduled activities can be enacted.

11. The system of claim 1, wherein the activity network specification comprises activity ordering relations that are processed by the data-triggered workflow engine to determine a preferred order in which to enact scheduled activities.

12. The system of claim 1, wherein the activity specification further comprises an auto-routing specification comprising rules for specifying a data item to copy and a location associated with the activity where to send the copied data item.

13. The system of claim 12, wherein the auto-routing rules comprise one of a mandatory auto-routing rule, a preferred auto-routing rule, and both.

14. The system of claim 12, further comprising an auto-routing server for scheduling and managing movement of copied data items.

15. The system of claim 1, wherein the activity specification further comprises an archive specification for specifying data to be archived and an archive location.

16. The system of claim 15, further comprising an archive server for copying a data item and sending the copied data item to a specified archive location.

17. The system of claim 16, wherein the data-triggered workflow engine delays completion of the transaction associated with an activity until notification is received from the archive server that a copying process is complete.

18. The system of claim 1, wherein the process definition further comprises a state-based schedule rules specification for supporting both simulation of state-based scheduling and responding to unscheduled activities changes to work-flow relevant data.

19. The system of claim 18, wherein the state-based schedule rules each comprise an in-out-consistent predicate and a prefix-consistent predicate.

20. A method for executing a data-triggered process, comprising the steps of:
generating a process instance from a process definition;
determining which activities associated with the process instance are scheduled for enactment based on activity specifications; and
computing an order in which scheduled activities can be enacted based on activity specifications and a current execution state of the process instance.

21. The method of claim 20, further comprising the step of displaying a list of scheduled activities for selection by a participant of a desired scheduled activity.

22. The method of claim 20, further comprising the step of recomputing an order in which scheduled activities can be enacted, if necessary, upon a change of state of an enacted activity.

23. The method of claim 20, further comprising the steps of:
determining if an unscheduled activity is permitted to be enacted based on activity specifications; and
enacting the unscheduled activity if it is permitted.

24. The method of claim 20, further comprising the steps of:
determining if an activity is expected to be enacted during execution of the process instance based on activity specifications; and
preparing for enactment of the activity if it is expected.

25. The method of claim 20, further comprising the step of upon finishing an enacted activity, generating a message specifying a state of completion of the activity, recording the state of completion in a job record of the activity, and reevaluating rules of subsequent activities, if necessary, based on the state of completion.

26. The method of claim 20, wherein the step of computing an order in which scheduled activities can be enacted comprises using a resources specification of a scheduled activity to determine a priority of the scheduled activity.

27. The method of claim 20, further comprising the step of automatically routing a data item associated with an activity based on activity specifications.

28. The method of claim 20, further comprising the step of automatically archiving a data item associated with an activity based on activity specifications.

29. A program storage device readable by a machine, tangibly embodying a program of instructions executable by the machine to perform method steps for executing a data-triggered process, the method steps comprising:
generating a process instance from a process definition;
determining which activities associated with the process instance are scheduled for enactment based on activity specifications; and
computing an order in which scheduled activities can be enacted based on activity specifications and a current execution state of the process instance.

30. The program storage device of claim 29, further comprising instructions for performing the step of displaying a list of scheduled activities for selection by a participant of a desired scheduled activity.

31. The program storage device of claim 29, further comprising instructions for performing the step of recomputing an order in which scheduled activities can be enacted, if necessary, upon a change of state of an enacted activity.

32. The program storage device of claim 29, further comprising instructions for performing the steps of:
determining if an unscheduled activity is permitted to be enacted based on activity specifications; and
enacting the unscheduled activity if it is permitted.

33. The program storage method of claim 29, further comprising instructions for performing the steps of:
determining if an activity is expected to be enacted during execution of the process instance based on activity specifications; and
preparing for enactment of the activity if it is expected.

34. The program storage device of claim 29, further comprising instructions for performing the steps of upon finishing an enacted activity, generating a message specifying a state of completion of the activity, recording the state of completion in a job record of the activity, and reevaluating rules of subsequent activities, if necessary, based on the state of completion.

35. The program storage device of claim 29, wherein the instructions for performing the step of computing an order in which scheduled activities can be enacted comprise instructions for utilizing a resources specification of a scheduled activity to determine a priority of the scheduled activity.

36. The program storage device of claim 29, further comprising instructions for performing the step of automatically routing a data item associated with an activity based on activity specifications.

37. The program storage device of claim 29, further comprising instructions for performing the step of automatically archiving a data item associated with an activity based on activity specifications.
